(19) United States
(12) Patent Application Publication
(10) Pub. No.: US 2024/0359621 A1
(43) Pub. Date: Oct. 31, 2024

(54) Vehicle Processing Systems And Methods For Stimulating Animal Behavior

(71) Applicant: Arriver Software AB, San Diego, CA (US)

(72) Inventors: Gustav Lars Henrik JAGBRANT, LINKÖPING (SE); Gustav Nils Ture PERSSON, Ljungsbro (SE); Per CRONVALL, Linköping (SE)

(21) Appl. No.: 18/309,209

(22) Filed: Apr. 28, 2023

(51) Int. Cl. B60Q 5/00; B60Q 1/04

(52) U.S. Cl. CPC B60Q 5/005; B60Q 1/04; B60Q 2300/312; B60Q 2300/314; B60Q 2300/32; B60Q 2300/33

(57) ABSTRACT

Various embodiments include methods and vehicle processing systems implementing such methods for protecting vehicles from dangers caused by animals on or near the roadway. In various embodiments, a vehicle processing system may perform a recognition process to identify an animal detected in proximity to the vehicle, perform a plurality of simulations of outcomes for the vehicle and other vehicles resulting from stimulating the identified animal using multiple different stimuli modes of the vehicle signal devices in which each different stimuli mode is predicted to elicit different animal behaviors, select one of the different stimulus modes to be performed by vehicle signal devices to elicit a behavior of the identified animal based on the plurality of simulated outcomes for the vehicle and other vehicles, and control signal devices of the vehicle to perform the selected stimulus.

### BACKGROUND

Vehicle accidents involving animals are a significant problem, causing both human and monetary costs. For example, according to the Federal Highway Administration, in the US alone there are around 1-2 million crashes with large animals every year, causing approximately 200 human deaths, 26 000 injuries and at least $8 billion in damages and other costs. Since animals are difficult to control the typical solution is to alleviate the problem through infrastructure investments such as animal fences. While this works to some degree, it is an expensive solution that can only be applied to a limited number of roads.

Modern vehicles often employ advanced driver assist systems (ADAS) systems that can detect objects in and near the roadway (e.g., based on radar and cameras) and perform automatic braking or steering maneuvers to avoid hitting the obstacles including animals in the roadway. These systems are however limited in that they only control the vehicle itself and do not attempt to control the behavior of the encountered animal(s), thereby limiting the extent to which they can prevent accidents.

### SUMMARY

Various aspects include methods that may be performed by a processing system of a vehicle for reducing risks of colliding with an animal entering the roadway by selectively stimulating an animal behavior. Various aspects may include a vehicle processing system performing a recognition process to identify an animal detected in proximity to the vehicle, performing a plurality of simulations of outcomes for the vehicle and other vehicles resulting from stimulating the identified animal using multiple different stimuli modes of the vehicle signal devices in which each different stimuli mode is predicted to elicit different animal behaviors, selecting one of the different stimuli modes to be performed by vehicle signal devices to elicit a behavior of the identified animal based on the plurality of simulated outcomes for the vehicle and other vehicles, and controlling the vehicle signal devices to perform the selected stimulus mode.

In some aspects, the plurality of simulations of outcomes for the vehicle and other vehicles resulting from stimulating the identified animal using multiple different stimuli modes of the vehicle signal devices may use information regarding behaviors of the identified animal obtained from a database accessible by a processor of the vehicle. In some aspects, the plurality of simulations of outcomes for the vehicle and other vehicles resulting from stimulating the identified animal using multiple different stimuli modes of the vehicle signal devices may use information regarding behaviors of the identified animal provided as an output by a trained artificial intelligence (AI) model executed by a processor of the vehicle.

Some aspects may include identifying one or more road conditions, wherein the plurality of simulations of outcomes for the vehicle and other vehicles resulting from stimulating the identified animal using multiple different stimuli modes of the vehicle signal devices take into account the identified one or more road conditions. Some aspects may include identifying one or more traffic conditions, wherein the plurality of simulations of outcomes for the vehicle and other vehicles resulting from stimulating the identified animal using multiple different stimuli modes of the vehicle signal devices take into account the identified one or more traffic conditions. Some aspects may include identifying ambient lighting conditions, wherein the plurality of simulations of outcomes for the vehicle and other vehicles resulting from stimulating the identified animal using multiple different stimuli modes of the vehicle signal devices take into account the identified ambient lighting conditions. Some aspects may include identifying one or more weather conditions, wherein the plurality of simulations of outcomes for the vehicle and other vehicles resulting from stimulating the identified animal using multiple different stimuli modes of the vehicle signal devices take into account the identified one or more one or more weather conditions.

In some aspects, the plurality of simulations of outcomes for the vehicle and other vehicles resulting from stimulating the identified animal using multiple different stimuli modes of the vehicle signal devices take into account probabilities of each of a plurality of behaviors that the identified animal may perform in response to each stimulus mode. In some aspects, performing the plurality of simulations of outcomes for the vehicle and other vehicles resulting from stimulating the identified animal using multiple different stimuli modes of the vehicle signal devices may include performing Monte Carlo simulations of outcomes for the vehicle and other vehicles that take into account probabilities of animal behaviors, vehicle behaviors, and driver reactions.

In some aspects, performing a plurality of simulations of outcomes for the vehicle and other vehicles resulting from stimulating the identified animal using multiple different stimuli modes of the vehicle signal devices in which each different stimuli mode is predicted to elicit different animal behaviors includes performing the plurality of simulations of outcomes for the vehicle and other vehicles in offline simulations to generate a training database, and applying the training database to a machine learning model to generate a trained AI model that can be implemented in a vehicle processor; and selecting one of the different stimuli modes to be performed by vehicle signal devices to elicit a behavior of the identified animal based on the plurality of simulated outcomes for the vehicle and other vehicles includes applying at least vehicle sensor, map and traffic data into the trained AI model in the vehicle processor and receiving as an output one of the different stimuli modes to be performed by vehicle signal devices.

Further aspects include a vehicle processing system including a memory and a processor configured to perform operations of any of the methods summarized above. Further aspects may include a vehicle processing system having various means for performing functions corresponding to any of the methods summarized above. Further aspects may include a non-transitory processor-readable storage medium having stored thereon processor-executable instructions configured to cause a processor of a vehicle processing system to perform various operations corresponding to any of the methods summarized above.

### BRIEF DESCRIPTION OF THE DRAWINGS

The accompanying drawings, which are incorporated herein and constitute part of this specification, illustrate exemplary embodiments of the claims, and together with the general description given and the detailed description, serve to explain the features herein.

FIG. 1A is a system block diagram illustrating an example communication system suitable for implementing various embodiments.

FIG. 1B is a system block diagram illustrating an example disaggregated base station architecture suitable for implementing various embodiments.

FIG. 2 is a component diagram of an example vehicle processing system suitable for implementing various embodiments.

FIG. 3A is a block diagram illustrating components of a system on chip for use in a vehicle processing system in accordance with various embodiments.

FIG. 3B is a component block diagram illustrating elements of a vehicle processing system configured in accordance with various embodiments.

FIG. 4 is a block diagram illustrating a vehicle processing system of a vehicle for stimulating animal behavior in accordance with various embodiments.

FIG. 5 is a process flow diagram of an example method performed by a processor of a vehicle processing system for stimulating proximate animal behavior in accordance with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and vehicle processing systems implementing such methods for stimulating animal behavior to elicit a behavior from an identified animal that is proximate to a vehicle to reduce the risk of an accident. In various embodiments, the vehicle processing system may be configured to identify the animal, conduct a plurality of simulated outcomes for the vehicle and other vehicles for different animal responses to stimuli configured to evoke or elicit a behavior from the animal, and select a stimulus to be generated by one or more signal devices of the vehicle based on the plurality of simulated outcomes for the vehicle and other vehicles. Whereas merely startling or scaring the animal may cause the animal to behave in an undesirable way (e.g., panicking and running in front of the vehicle, or running in front of another vehicle), various embodiments enable a vehicle processing system to apply information about the identified animal and the animal's possible or likely reaction to various stimuli, simulate how different stimulated animal responses may affect the vehicle and other nearby vehicles, and select a stimulus to be performed by the vehicle signal devices that is configured to elicit a behavior of the identified animal that is likely to result in an acceptable, desirable, least dangerous to people, or otherwise best one of the simulated alternative outcomes for the vehicle and nearby vehicles.

As used herein, the term “vehicle” refers generally to any of an automobile, motorcycle, truck, bus, train, boat, and any other type of vehicle V2X-capable system that may be configured to manage transmission of misbehavior reports.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

Vehicles may employ computing systems such as automobile driver assist systems (ADAS) systems that are configured to detect objects in and near the roadway based on information from sensors such as radar and cameras. Such computing systems also may be configured to perform operations for path planning and maneuvering to avoid such detected objects. While such computing systems also may be configured to detect and avoid animals on or near the road, such systems are limited in that they only control the vehicle itself (the “ego vehicle”) and do not attempt to control the behavior of an encountered animal. The animal may behave in a manner that causes the collision that the computing system is attempting to avoid, for example, by freezing in panic on a roadway, or by running into the path of the vehicle.

Various embodiments include a processing system of a vehicle (a “vehicle processing system”) for identifying animals near the vehicle, simulating or estimating how different animal reactions to stimulus could impact the vehicle as well as other vehicles in the vicinity, selecting a behavior that will result in an acceptable, desirable, least dangerous to people, or otherwise or best one of the simulated alternative outcomes, and generating the stimulus that will result in stimulating the selected behavior of the detected animal (“animal behavior”).

In various embodiments, the vehicle processing system may detect that an animal is on or near the roadway ahead of the vehicle (e.g., on or near a roadway on which is the vehicle is traveling), and perform operations to identify the animal detected in proximity to the vehicle. In some embodiments, the vehicle processing system may identify a current movement or activity of the animal (e.g., sitting, walking, running, grazing, and the like). Identifying the animal may include determining the species as well as size and sex, as animals of different species, sex and size may behave differently in response to various stimuli. In some embodiments, the vehicle processing system may apply information received from vehicle sensors to a trained artificial intelligence (AI) model (e.g., a trained machine learning model, trained neural network, etc.) that can provide an identification of an animal as an output. In some embodiments, the trained AI model may provide as an output a detailed characterization of the animal, for example, an indication of the sex of the animal, the age of the animal, a subtype of the animal, and/or other characteristics of the animal.

In various embodiments, the vehicle processing system may perform simulations of outcomes for the vehicle and other vehicles resulting from different behavior responses of the detected animal that may be elicited by producing different stimuli. The purpose of such simulations is to provide a mechanism by which the vehicle processing system can select a particular animal stimulus (e.g., combination of lights and sound) that will most likely prompt the detected animal to behave (e.g., move or stay still) under the circumstances of the animals movement or activity in a manner that will result in an acceptable or best one of multiple simulated outcomes for the vehicle and other vehicles in the vicinity in view of roadway conditions, weather conditions, traffic conditions, season, time of day, etc. For example, stimulating an animal to move in a direction that crosses the path of oncoming traffic could results in worse outcomes (e.g., causing a worse collision by another vehicles, causing a head-on collision between approaching vehicles, etc.) than stimulating the animal to move in the other direction (leaving the roadway) or freeze if the vehicle is capable of minimizing consequences through braking alone. A rules-based decision model for selecting among alternative animal stimuli is impractical given the infinite possible situations of an animal on or near the roadway in terms of animal species and size, distance at detection, vehicle speed, roadway conditions, and other vehicle positions, directions and speeds, etc. Using simulations of outcomes based on the current circumstances provides a method for the vehicle processing system to select an appropriate animal stimuli to use.

In various embodiments, such simulations may take into account facts determinable by the vehicle processing system based on sensor data and vehicle state information. In particular, the simulations may take as inputs the speed of the vehicle, distance to the detected animal, roadway conditions (e.g., dry pavement, wet, icy, etc.), weather conditions, roadway dimensions (e.g., width, lanes, incline, curvature ahead, boarder or shoulder conditions, etc.), and other own-vehicle information relevant to stopping distance, braking efficiency, steering control, etc. Further, the simulations may use vehicle sensor information to receive as inputs the number, locations, speeds, directions and types of other vehicles in the vicinity (e.g., in parallel lanes and same or opposite directions of travel) that could be affected by stimulated animal behavior.

In various embodiments, such simulations may also take into account information regarding how different types (species, sex, size, etc.) of animals behave in different conditions (day, night, rain, snow, etc.), in various seasons (spring, summer, fall, winter), and in various environments (forests, plains, desert, urban, etc.) and prior movements or activities in response to or in reaction to different combinations of stimuli that the vehicle can make (e.g., flashing lights, sounding horn, broadcasting different sounds, illuminating with lights of various wavelengths, etc.), which are referred to herein as “stimuli modes.”

The simulation may make use of information stored in a vehicle processing system, and may be configured with, or to have access to, a database (e.g., a listing, etc.) of possible stimuli modes for motivating animal behaviors of specific animals, including how each animal is likely to respond to specific mixtures of audio (e.g., horns, sirens, other sounds) and visual (e.g., flashing lights) stimulus. Such a database of animal behaviors in response to stimuli may be generated through animal research. Such research may identify stimulus patterns that tend to guide a particular type of animal off the roadway, to make the animal stand still before entering the roadway, or to make the animal stand still on the roadway (e.g., to enable vehicles to brake or perform evasive maneuvers safely). For example, a reindeer, deer, or other similar animal may be dazzled by light and freeze in place, whereas a cat or rabbit may follow a spot of light. Certain other animals, such as porcupines, armadillos, and opossum, may assume a defensive crouch or posture in response to certain stimuli. Yet other animals, such as skunks, may turn their heads and/or bodies away from a perceived threat (e.g., in preparation to emit their characteristic defensive spray), and may be unable to perceive certain stimuli (e.g., visual stimuli), yet remain able to perceive other stimuli (e.g., audible stimuli). In some embodiments this database could be complemented by or replaced with a trained AI model (i.e., a trained machine learning model, trained neural network, etc.). Such a trained AI model could also receive sensor data as inputs and explicitly or implicitly model animal responses to stimuli depending on environmental parameters.

In some embodiments, the vehicle processing system may perform as many simulations as there are different behavior responses to stimuli that can be generated by the vehicle that are stored in the database. Such simulations may be based on the identified animal, road conditions, traffic conditions, ambient lighting conditions, and weather conditions, and predict how the animal's behavior in response to a given stimulus will affect the vehicle and other vehicles using braking and steering calculations within the dimensions of the roadway.

For example, if the database includes three alternative behaviors (e.g., move left, move right, or freeze) that may be prompted by three different stimuli, the vehicle processing system may perform three different simulations in which the animal's behavior is projected and then the response of the vehicle and other vehicles to that behavior may be predicted. Continuing this example, in a simulation in which the animal is prompted to move out of the vehicle's lane and into the lane of on-coming traffic, the simulation may model the responses of oncoming vehicles to determine whether such vehicles can brake in time to avoid hitting the animal and if not estimate a probability that an oncoming vehicle could swerve into the vehicle's lane resulting in the undesirable outcome of a head on collision. In another simulation in which the animal is prompted to freeze, and thus remain in the vehicle's path, the simulation may model the vehicles braking performance and estimate its speed upon colliding with the animal if a collision would happen at all. Another simulation may model the outcome of a stimulus that is likely to cause the animal to leave the roadway without crossing in front of oncoming traffic. In this example, stimulating the animal to leave the roadway without crossing the center line would be best one of the multiple alternative simulated outcomes if the vehicle cannot avoid a collision by braking because a collision or accident involving other vehicles is avoided. However, causing the animal to freeze when there is sufficient distance to avoid a collision by braking may be preferrable when there is other traffic on the roadway. In some situations, a collision with the animal may be the least dangerous (and thus “best”) one of the various simulation outcomes. For example, the vehicle processing system may determine that a collision with a small animal is preferable to causing the animal to run in front of other vehicles, which may cause (or have a greater probability or likelihood of causing) a larger disruption to traffic or an automobile accident.

In such simulations, the vehicle processing system may model how the vehicle and other vehicles will perform on identified roadway conditions. Such road conditions may include a road size (e.g., a width or a number of lanes), a road geometry (e.g., a road shape, or areas where the road changes shape), a location of road edges, whether the road is well paved, or worn, or is unpaved, whether the road is warm, cold, wet, oily, slippery, icy, and the like, the presence or absence of guardrails, dividers, and other structures, and other suitable road conditions.

In such simulations, the vehicle processing system may identify one or more traffic conditions, and may select the stimulus to be performed based on the traffic conditions. For example, the roadway may be empty of other vehicles, congested with other vehicle, have intermittent traffic, and the like. In some embodiments, the vehicle processing system may select the stimulus based on a predicted effect of the elicited animal behavior on other vehicles, based on the traffic conditions.

In each simulation the vehicle processing system may estimate a probability of outcomes given that animals may not act as predicted, vehicle braking and steering performance may vary and other drivers may react in unpredictable ways under the circumstances. To accommodate the various alternative scenarios and associated probabilities, the simulation may use Monte Carlo simulation techniques to weigh numerous possible animal behaviors in response to various stimuli that the vehicle can generate or produce.

Based on the output of the various simulations, the vehicle processing system may select the stimulus to be performed by the vehicle signal devices that is projected to elicit the behavior of the identified animal that is projected (e.g., has highest likelihood) of resulting in a best one or least dangerous of various simulation outcomes. The vehicle processing system may select the stimulus to be performed by signal devices of the vehicle (“vehicle signal devices”), such as flashing headlights or other lights of the vehicle, honking a horn or emitting another audio signal from the vehicle, or another suitable stimulus.

The vehicle processing system may then control the vehicle signal devices to perform the selected stimulus. In various embodiments, the vehicle signal devices may be configured to be controllable by the vehicle processing system to generate such stimulus. For example, vehicle lights may be controllable to change the direction of light emission, the frequency of light emitted, to emit light intermittently, periodically, and/or in a pattern. As another example, vehicle sound emitters may be controllable to change a direction, frequency (e.g., in Hertz), pattern, volume (e.g., sound pressure level), and/or another parameter of sound emission.

In some embodiments, the vehicle processing system may adjust or update a database (e.g., a database of animal behaviors) based on a location of the vehicle or other factors, such as season of the year, or time of day. For example, a vehicle located in or traveling through a wooded area may store (or prioritize) information on animals that frequent such woods, while a vehicle located in or traveling through a different climate or biome may store (or prioritize) information on other endemic animals. In some embodiments, the vehicle processing system may request and/or receive such information from a computing device (e.g., a network server, another vehicle's processing system, a vehicle-to-everything (V2X) network element, or the like) via a communication signal (e.g., peer-to-peer) or communication network (such as a cellular network, a V2X network, and the like).

In some embodiments, the simulation (or multiple simulations) may be performed offline to generate training data that may be used to train a machine learning model to generate a trained AI model that can be implemented in a vehicle processor to obtain the decision-making advantages of the simulation methods without having to run such simulations in real time. Such a trained AI model may receive as inputs all forms of information that may be used in the offline simulations, including data from various vehicle sensors (e.g., cameras, radar, lidar, ultrasound, navigation systems, speedometer, etc.), map data (e.g., roadway curvature, lane count, surface conditions, surrounding environment, etc.), date and time-of-day, weather sensors (e.g., thermometer, precipitation sensors, etc.) and V2X network communications. The trained AI model may be trained to provide as an output a selected stimulus mode to implement in response to detecting an animal by the side of the road under the current conditions as described herein. Such a trained AI model may be instantiated in, or transmitted to, a vehicle processing system.

In some embodiments, training the machine learning model using simulations may incorporate the operations of detecting, recognizing, categorizing and predicting behaviors of an animal, and then outputting the selected stimuli to implement under current conditions (i.e., end-to-end training). In some embodiments, training the machine learning model using simulations may receive as an input animal behavior predictions (e.g., species, size, sex, stimulus-behavior patterns, etc.) from an AI model trained to recognize and categorize animals based on vehicle sensor data, and combine such animal behavior predictions with vehicle state, map, and traffic data, and output the stimuli to implement under current conditions (i.e., the system uses two trained AI models).

In such embodiments, the training data set may be generated by running simulations in an offline computing system (e.g., a supercomputer or cloud computing system) addressing every possible combination of animals and animal behaviors (including species, size, sex and predicted responses to various stimuli), locations, sensor inputs, vehicle states, roadway conditions, and traffic conditions to identify the stimuli that results in the best one of the simulation outcomes under each set of conditions. Monte Carlo simulation methods may be used to address the variability in animal responses to each type of stimuli. The resulting training data set may include the sensor data input into the simulation that serves as the input parameters to the machine learning model, with the stimuli identified to result in the an acceptable, desirable, least dangerous to people, or otherwise or best one of the simulation outcomes providing the truth set.

With the training data set generated in this manner, training of the machine learning model may proceed by applying the training database to a machine learning model to generate a trained AI model that can be implemented in a vehicle processor. Such training may use well known machine learning methods including transforming animal characteristics, map information, and traffic conditions into vectors, backpropagation from the truth set to arrive at weights the minimize the difference (referred to as cost), and transformer attention computations.

Implementing such a trained AI model in a vehicle processing system may speed up the process of selecting the appropriate stimuli to use under current roadway, vehicle and traffic conditions in response to detecting an animal. Moreover, a trained AI model capable of selecting the appropriate stimuli under current conditions and animal recognition may be implemented in a processor configured or optimized for running such models, avoiding the need for a computing system with the capacity of running multiple simulations within the time frame available for responding to the detection of an animal on or near the roadway.

Various embodiments improve the safety of a motor vehicle by enabling a vehicle processing system to produce a stimulus that is selected to elicit a behavior for the particular identified animal that is likely to minimize or reduce adverse consequences of an animal approaching or entering the roadway. Various embodiments improve vehicle and traffic safety by enabling an additional element of control over animals proximate to a roadway taking into account many factors and possible alternative outcomes, enabling safer driving conditions, as well as improved outcomes for animals in and around roadways.

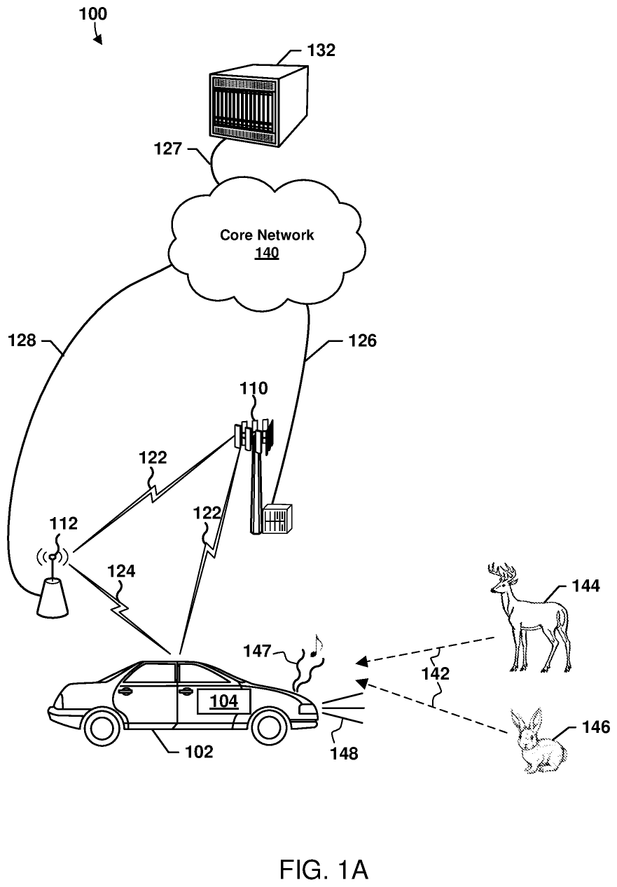

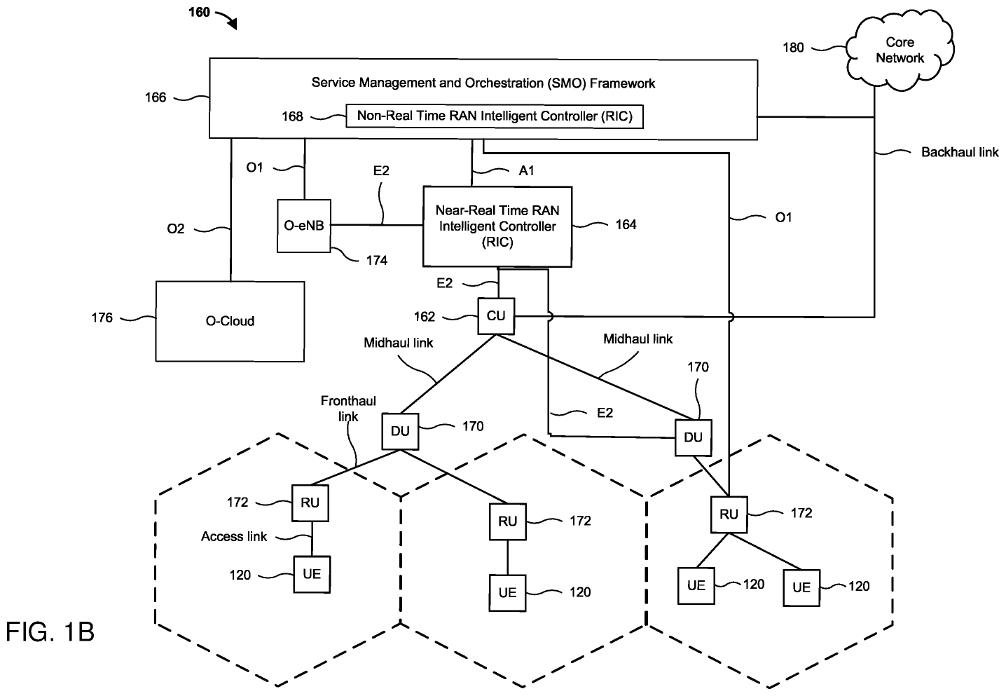

FIG. 1A is a system block diagram illustrating an example communication system 100 suitable for implementing the various embodiments. The communications system 100 include a 5G New Radio (NR) network, an intelligent transportation system (ITS) V2X wireless network, and/or any other suitable network such as a Long Term Evolution (LTE) network. References to a 5G network and 5G network elements in the following descriptions are for illustrative purposes and are not intended to be limiting.

The communications system 100 may include a heterogeneous network architecture that includes a core network 140, a number of base stations 110, and a variety of mobile devices including vehicles 102 that may be equipped with a vehicle processing system 104 that includes wireless communication capabilities. The base station 110 may communicate with a core network 140 over a wired communication link 126. The communications system 100 also may include roadside units 112 supporting V2X communications with vehicles 102 via V2X wireless communication links 124. The vehicles 102 may be configured to communicate via wireless communication 124. In some embodiments, the wireless communication 124 may include a wireless communication link. In some embodiments, the wireless communication 124 may represent a connection-less communication scheme, such as connection-less groupcast.

A base station 110 is a network element that communicates with wireless devices (e.g., a vehicle processing system 104 of the vehicle 102) via a wireless communication link 122, and may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. Each base station 110 may provide communication coverage for a particular geographic area or “cell.” In 3GPP, the term “cell” can refers to a coverage area of a base station, a base station subsystem serving this coverage area, or a combination thereof, depending on the context in which the term is used. The core network 140 may be any type of core network, such as an LTE core network (e.g., an evolved packet core (EPC) network), 5G core network, a disaggregated network as described with reference to FIG. 1B, etc.

Roadside units 112 may communicate with the core network 140 via a wired or wireless communication link 128. Roadside units 112 may communicate via V2X wireless communication links 124 with V2X processing system-equipped vehicles 102 for downloading information useful for V2X processing system autonomous and semi-autonomous driving functions, and for receiving information such as misbehavior reports from the vehicle processing system 104.

A network computing device 132 may communicate with the core network 140 via a wired or wireless communication link 127. The network computing device 132 may be configured to transmit to the vehicle processing system 104 information that enables the vehicle processing system to perform a recognition process to identify an animal detected in proximity to the vehicle 102. In some embodiments, vehicle processing system 104 may store such information in a data structure, such as a database. In some embodiments, the vehicle processing system 104 may use such information as part of a trained AI model to rapidly identify an animal and various characteristics of the identified animal, such as possible behaviors of the animal in response to various stimuli that the vehicle processing system 104 may control the vehicle 102 to produce. In some embodiments, the vehicle processing system 104 may receive from the network computing device 132 the trained AI model, and may execute the trained AI model. In some embodiments, vehicle processing system 104 may alter, improve, or adapt the trained AI model based on information received from the network computing device 132. In some embodiments, the vehicle processing system 104 may alter, improve, or adapt the trained AI model based on feedback generated as part of the operations performed by the trained AI model and/or by the vehicle processing system.

For example, the vehicle processing system 104 may receive information from vehicle sensors that perceive 142 an animal 144, 146 proximate to the vehicle. The vehicle processing system may perform a recognition process to identify the animal 144, 146, and may select a stimulus to be performed by vehicle signal devices that is configured to elicit a behavior of the identified animal 144, 146 relative to the vehicle 102. For example, the vehicle processing system 104 may control lights 148 of the vehicle to emit light in a specified manner, or may control a horn or other sound emitter 147 to emit sound in a specified manner, may control another vehicle signal device to emit another suitable signal.

Wireless communication links 122 may include a plurality of carrier signals, frequencies, or frequency bands, each of which may include a plurality of logical channels. The wireless communication links 122 and 124 may utilize one or more radio access technologies (RATs). Examples of RATs that may be used in a wireless communication link include 3GPP LTE, 3G, 4G, 5G (e.g., NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

FIG. 1B is a system block diagram illustrating an example disaggregated base station 160 architecture that may be part of a V2X and/or 5G network (e.g., the communication system 100) according to any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUs) 172 via respective fronthaul links. The RUs 172 may communicate with respective UEs 120 via one or more radio frequency (RF) access links. In some implementations, user equipment (UE), such as a vehicle processing system 104, may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based radio access network (RAN) architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an AI interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as AI policies).

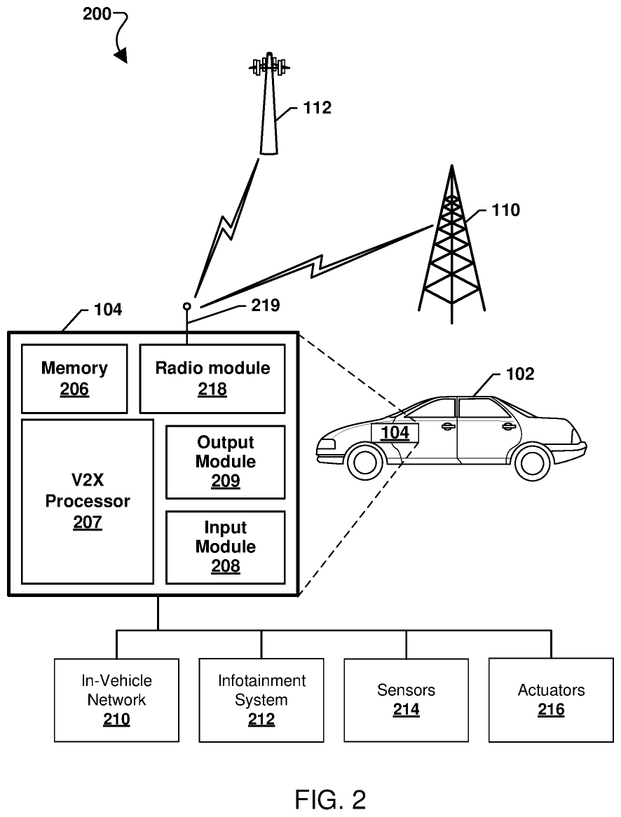

FIG. 2 is a component diagram of an example vehicle processing system 200 suitable for implementing various embodiments. With reference to FIGS. 1A-2, the vehicle processing system 200 may include a vehicle 102 that includes a vehicle processing system 104. The vehicle processing system 104 may communicate with various systems and devices, such as an in-vehicle network 210, an infotainment system 212, various sensors 214, various actuators 216, and a radio module 218 coupled to an antenna 219. The vehicle processing system 104 also may communicate with roadside units 112, cellular communication network base stations 110, and other external devices.

The vehicle processing system 104 may include a processor(s) 207, memory 206, an input module 208, an output module 209 and the radio module 218. The processor(s) 207 may be coupled to the memory 206 (i.e., a non-transitory storage medium), and may be configured with processor-executable instructions stored in the memory 206 to perform operations of the methods according to various embodiments described herein. Also, the processor(s) 207 may be coupled to the output module 209, which may control in-vehicle displays, and to the input module 208 to receive information from vehicle sensors as well as driver inputs.

The vehicle processing system 104 may include an antenna 219 coupled to the radio module 218 that is configured to communicate with one or more ITS participants (e.g., stations), a roadside unit 112, and a base station 110 or another suitable network access point. The antenna 219 and radio module 218 may be configured to receive information about animals and animal behavior, and/or updates to or a replacement of a trained AI model, as well as transmit and receive other information, e.g., dynamic traffic flow feature information via vehicle-to-everything (V2X) communications. In various embodiments, the processing system may receive information from a plurality of information sources, such as the in-vehicle network 210, infotainment system 212, various sensors 214, various actuators 216, and the radio module 218. The processing system 200 may be configured to perform autonomous or semi-autonomous driving functions using map data in addition to sensor data, as further described below.

Examples of an in-vehicle network 210 include a Controller Area Network (CAN), a Local Interconnect Network (LIN), a network using the FlexRay protocol, a Media Oriented Systems Transport (MOST) network, and an Automotive Ethernet network. Examples of vehicle sensors 214 include a location determining system (such as a Global Navigation Satellite Systems (GNSS) system, a camera, radar, lidar, ultrasonic sensors, infrared sensors, and other suitable sensor devices and systems. Examples of vehicle actuators 216 include various physical control systems such as for steering, brakes, engine operation, lights, directional signals, and the like.

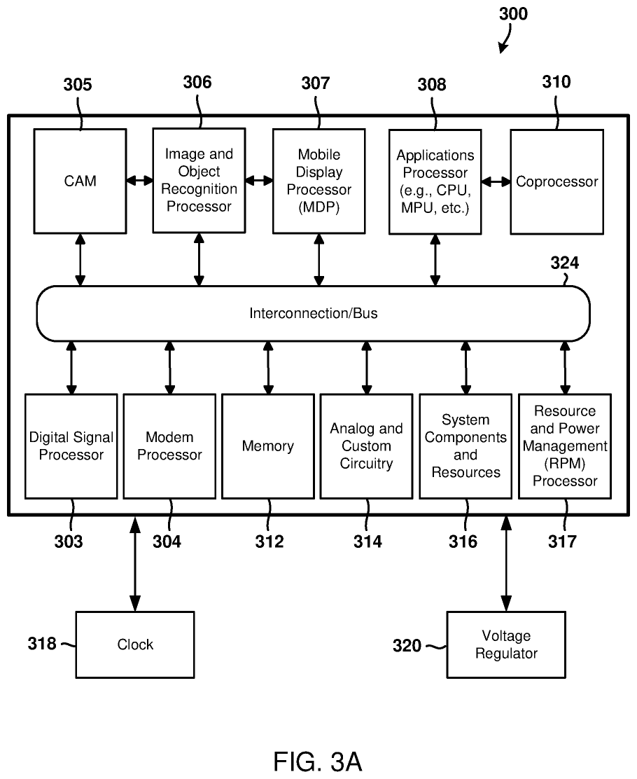

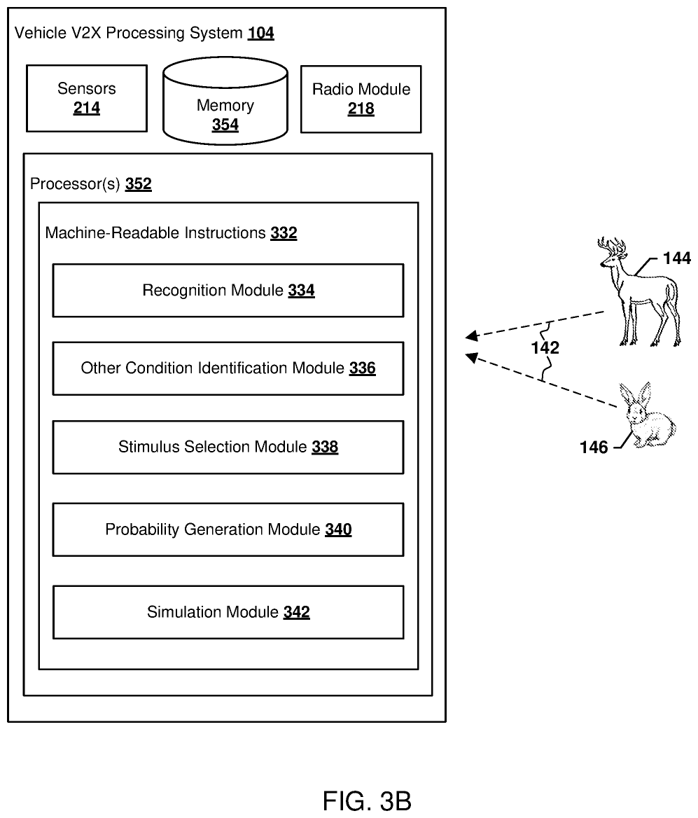

FIG. 3A is a block diagram illustrating example components of a system on chip (SOC) 300 for use in a vehicle processing system in accordance with various embodiments. With reference to FIGS. 1A-3A, the processing device SOC 300 may include a number of heterogeneous processors, such as a digital signal processor (DSP) 303, a modem processor 304, an image and object recognition processor 306, a mobile display processor 307, an applications processor 308, and a resource and power management (RPM) processor 317. The processing device SOC 300 may also include one or more coprocessors 310 (e.g., vector co-processor) connected to one or more of the heterogeneous processors 303, 304, 306, 307, 308, 317.

Each of the processors may include one or more cores, and an independent/internal clock. Each processor/core may perform operations independent of the other processors/cores. For example, the processing device SOC 300 may include a processor that executes a first type of operating system (e.g., FreeBSD, LINUX, OS X, etc.) and a processor that executes a second type of operating system (e.g., Microsoft Windows). In some embodiments, the applications processor 308 may be the SOC's 300 main processor, central processing unit (CPU), microprocessor unit (MPU), arithmetic logic unit (ALU), etc. The graphics processor 306 may be graphics processing unit (GPU).

The processing device SOC 300 may include analog circuitry and custom circuitry 314 for managing sensor data, analog-to-digital conversions, wireless data transmissions, and for performing other specialized operations, such as processing encoded audio and video signals for rendering in a web browser. The processing device SOC 300 may further include system components and resources 316, such as voltage regulators, oscillators, phase-locked loops, peripheral bridges, data controllers, memory controllers, system controllers, access ports, timers, and other similar components used to support the processors and software clients (e.g., a web browser) running on a computing device.

The processing device SOC 300 also include specialized circuitry for camera actuation and management (CAM) 305 that includes, provides, controls and/or manages the operations of one or more cameras (e.g., a primary camera, webcam, 3D camera, etc.), the video display data from camera firmware, image processing, video preprocessing, video front-end (VFE), in-line JPEG, high definition video codec, etc. The CAM 305 may be an independent processing unit and/or include an independent or internal clock.

In some embodiments, the image and object recognition processor 306 may be configured with processor-executable instructions and/or specialized hardware configured to perform image processing and object recognition analyses involved in various embodiments. For example, the image and object recognition processor 306 may be configured to perform the operations of processing images received from cameras via the CAM 305 to recognize and/or identify other vehicles and their behavior, road conditions, animals, and other objects and conditions useful in simulating animal responses to stimuli. In some embodiments, the processor 306 may be configured to process radar or lidar data, for example, to recognize and/or identify other vehicles and their behavior, road conditions, animals, and other objects and conditions useful in simulating animal responses to stimuli.

The system components and resources 316, analog and custom circuitry 314, and/or CAM 305 may include circuitry to interface with peripheral devices, such as cameras, radar, lidar, electronic displays, wireless communication devices, external memory chips, etc. The processors 303, 304, 306, 307, 308 may be interconnected to one or more memory elements 312, system components and resources 316, analog and custom circuitry 314, CAM 305, and RPM processor 317 via an interconnection/bus module 324, which may include an array of reconfigurable logic gates and/or implement a bus architecture (e.g., CoreConnect, AMBA, etc.). Communications may be provided by advanced interconnects, such as high-performance networks-on chip (NoCs).

The processing device SOC 300 may further include an input/output module (not illustrated) for communicating with resources external to the SOC, such as a clock 318 and a voltage regulator 320. Resources external to the SOC (e.g., clock 318, voltage regulator 320) may be shared by two or more of the internal SOC processors/cores (e.g., a DSP 303, a modem processor 304, a graphics processor 306, an applications processor 308, etc.). In some embodiments, the processing device SOC 300 may be included in a control unit (e.g., vehicle processing system 104) for use in a vehicle (e.g., 102).

The processing device SOC 300 may also include additional hardware and/or software components that are suitable for collecting sensor data from sensors, including motion sensors (e.g., accelerometers and gyroscopes of an IMU), user interface elements (e.g., input buttons, touch screen display, etc.), microphone arrays, sensors for monitoring physical conditions (e.g., location, direction, motion, orientation, vibration, pressure, etc.), cameras, compasses, Global Positioning System (GPS) receivers, communications circuitry (e.g., Bluetooth®, WLAN, WiFi, etc.), and other well-known components of modern electronic devices.

FIG. 3B is a component block diagram illustrating elements of a vehicle processing system 104 configured in accordance with various embodiments. With reference to FIGS. 1A-3B, the vehicle processing system 104 may include one or more processors 352 (e.g., 207, 303, 304, 306, 307, 308, 310), memory 354 (e.g., 206, 312), various sensors 214, a radio module 218, and other components. The vehicle processing system 104 may include a plurality of hardware, software, and/or firmware components operating together to provide the functionality attributed herein to the processor(s) 352.

The memory 354 may include non-transitory storage media that electronically stores information. The electronic storage media of memory 354 may include one or both of system storage that is provided integrally (i.e., substantially non-removable) with the vehicle processing system 104 and/or removable storage that is removably connectable to the vehicle processing system 104 via, for example, a port (e.g., a universal serial bus (USB) port, a firewire port, etc.) or a drive (e.g., a disk drive, etc.). In various embodiments, memory 354 may include one or more of electrical charge-based storage media (e.g., EEPROM, RAM, etc.), solid-state storage media (e.g., flash drive, etc.), optically readable storage media (e.g., optical disks, etc.), magnetically readable storage media (e.g., magnetic tape, magnetic hard drive, floppy drive, etc.), and/or other electronically readable storage media.

The memory 354 may include one or more virtual storage resources (e.g., cloud storage, a virtual private network, and/or other virtual storage resources). Memory 354 may store software algorithms, information determined by processor(s) 352, information received from the sensors 214, information received from a network computing device (e.g., 132), and/or other information that enables the vehicle processing system 104 to function as described herein.

The processor(s) 352 may include one or more local processors that may be configured to provide information processing capabilities in the vehicle processing system 104. As such, the processor(s) 352 may include one or more of a digital processor, an analog processor, a digital circuit designed to process information, an analog circuit designed to process information, a state machine, and/or other mechanisms for electronically processing information. Although the processor(s) 352 is shown in FIG. 3B as a single entity, this is for illustrative purposes only. In some embodiments, the processor(s) 352 may include a plurality of processing units. These processing units may be physically located within the same device, or the processor(s) 352 may represent processing functionality of a plurality of devices distributed in the vehicle (e.g., connected via a vehicle network) and operating in coordination.

The vehicle processing system 104 may be configured by machine-readable instructions 332, which may include one or more instruction modules. The instruction modules may include computer program modules. In various embodiments, the instruction modules may include one or more of a recognition module 334, an other condition identification module 336, a stimulus selection module 338, a probability generation module 340, a simulation module 342, and/or other modules.

The recognition module 334 may be configured to perform a recognition process to identify an animal detected in proximity to the vehicle. The recognition module 334 may be configured to identify behaviors of the identified animal that correlate with specific stimuli performed by vehicle devices.

The other condition identification module 336 may be configured to identify one or more other conditions in and around or proximate to the vehicle. In some embodiments, the other condition identification module may identify one or more road conditions, one or more traffic conditions, ambient lighting conditions, and/or one or more weather conditions.

The stimulus selection module 338 may be configured to select a stimulus to be performed by vehicle signal devices that is configured to elicit a behavior of the identified animal relative to the vehicle. The stimulus selection module 338 may be configured to select the stimulus of the vehicle signal devices that is most likely to elicit a specific identified behavior of the animal.

The probability generation module 340 may be configured to generate a probability of each of a plurality of behaviors of the identified animal in response to a stimulus to be performed by the vehicle signal devices.

The simulation module 342 may be configured to perform a simulation based on the identified animal, one or more road conditions, one or more traffic conditions, ambient lighting conditions, and weather conditions, wherein the simulation provides as an output possible behaviors of the identified animal associated with one of a plurality of stimuli of the vehicle signal devices.

The processor(s) 352 may be configured to execute the modules 334-342 and/or other modules by software, hardware, firmware, some combination of software, hardware, and/or firmware, and/or other mechanisms for configuring processing capabilities on processor(s) 352. In some embodiments, one or more of the modules 334-342 may be implemented as or replaced by one or more trained AI models as described herein.

The description of the functionality provided by the different modules 334-342 is for illustrative purposes, and is not intended to be limiting, as any of modules 334-342 may provide more or less functionality than is described. For example, one or more of modules 334-342 may be eliminated, and some or all of its functionality may be provided by other ones of modules 334-342. As another example, processor(s) 207 may be configured to execute one or more additional modules that may perform some or all of the functionality attributed below to one of modules 334-342.

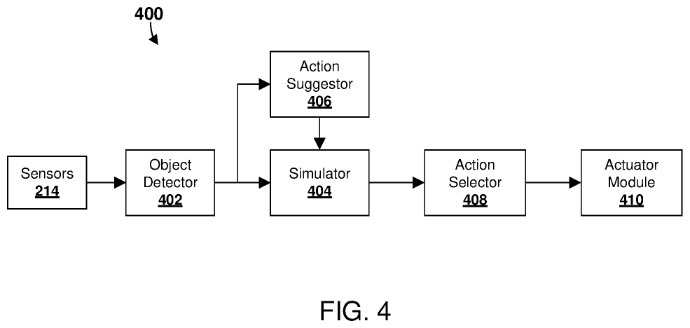

FIG. 4 is a block diagram illustrating a vehicle processing system 400 of a vehicle for stimulating animal behavior in accordance with various embodiments. With reference to FIGS. 1A-4, the vehicle processing system 400 may include a variety of modules that may be implemented in hardware elements, software elements, or a combination of hardware and software elements, executing one or more of such modules. The modules may be executed in a processing device of the vehicle (e.g., 207, 303, 304, 306, 307, 308, 310). The vehicle processing system 400 may include an object detector module 402, a simulator module 404, an action suggestor module 406, an action selector module 408, and an actuator module 410.

Vehicle sensors 214 may provide sensor information to the object detector module 402. The object detector module 402 may perform a recognition process using the sensor information to identify an animal detected in proximity to the vehicle. The object detector module 402 may provide as an output an identification of the animal to the simulator module 404 and/or the action suggestor module 406. The action suggestor module 406 may use the identification of the animal to generate possible actions that the vehicle processing system 400 may perform, including possible stimuli that the vehicle processing system 400 may generate (or perform) to elicit a behavior from the identified animal. The action suggestor module 406 may provide the generated possible actions as an output to the simulator module. In some embodiments, the action suggestor module 404 may generate a probability of each of a plurality of behaviors of the identified animal in response to a stimulus to be performed by the vehicle signal devices. The action suggestor module 406 may provide possible actions and, for each action, an associated probability distribution over possible elicited behaviors/reactions of the detected animal. The action suggestor module 406 may perform a database lookup to obtain information about animals and associated animal behaviors. The action suggestor module 406 may apply to a trained AI model a variety of information, including data received from sensors (e.g., 214) as input, information obtained from a database, and/or other information.

The simulator module 404 may use the identification of the animal and the possible actions to generate possible outcomes, including possible behaviors of the identified animal in response to particular stimuli. In some embodiments, the simulator module 404 may perform a simulation based on the identified animal and a variety of other factor (e.g., road conditions, traffic conditions, ambient lighting conditions, weather conditions, etc.) and may provide as an output to the action selector module 408 possible behaviors of the identified animal associated with one of a plurality of stimuli of the vehicle signal devices. In some embodiments, the simulator module 404 may provide as an output a cost computed by integrating over projected outcomes or probability distributions over outcomes associated with suggested (e.g., one or more possible) stimuli.

The action selector module 408 may use the possible behaviors of the identified animal associated with one of a plurality of stimuli of the vehicle signal devices to select a stimulus for performance by the vehicle processing unit 400. In some embodiments, the action selector module 408 may select a stimulus to be performed by vehicle signal devices that is configured to elicit a behavior of the identified animal relative to the vehicle.

In some embodiments, the action selector module 408 selects the stimulation action based on one or more simulations generated (performed, simulated) by the simulator module 404. In some embodiments, the action selector module 408 selects the action based on a drive policy of the system together with the one or more simulations generated (performed, simulated) by the simulator module 404. This may be achieved by simulating (by the simulator module 404) possible scenarios for each possible animal reaction to given stimuli and evaluating (by the action selector module 408) the result of the drive policy for each combination. In some embodiments, generating or performing a simulation may include modelling the behavior(s) and interaction(s) of agents in the scene (e.g., the vehicle performing the simulation, animal(s), and other vehicle(s)) and any resulting movement trajectories of the animal, own vehicle and other vehicles. In some embodiments, the action selector module 408 may generate a score for each result based on a likelihood of hazardous or discomforting events. In some embodiments, the action selector module 408 may aggregate the results using the reaction probabilities, and may select the action with the most favorable score or outcome parameter.

The action selector module 408 may provide the selected stimulus as an output to the actuator module 410. The actuator module 410 may control one or more signal devices of the vehicle (e.g., lights, sound emitters, or other suitable signal devices) to perform or generate the selected stimulus.

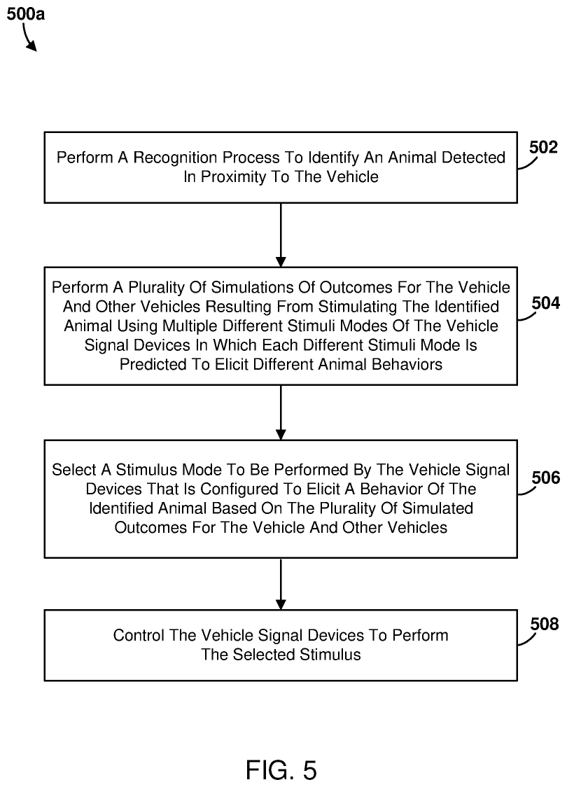

FIG. 5 is a process flow diagram of an example method 500a performed by a processor of a vehicle processing system for selecting an appropriate stimulus to elicit a behavior of an animal proximate to the vehicle based on results of a simulations in accordance with various embodiments. With reference to FIGS. 1A-5, means for performing the operations of the method 500a may include one or more processors (e.g., 207, 303, 304, 306, 307, 308, 310) of a vehicle processing system (e.g., 104, 400) that may be implemented in hardware elements, software elements, or a combination of hardware and software elements, executing one or more of the modules 334-342 or 402-410. To encompass any of the processors, hardware elements, and software elements that may configured to perform operations of the method 500a, such elements or subsystems are referred to generally as a “processor.”

In block 502, the processor may perform a recognition process to identify an animal detected in proximity to the vehicle. In some embodiments, the processor may use sensor information from one or more vehicle sensors to perform the recognition process. As part of the operations in block 502, the processor may determine the species as well as size and sex of the animal. In some embodiments in block 502 the vehicle processing system may apply information received from vehicle sensors to a trained AI model (e.g., a trained machine learning model, trained neural network, etc.) that is trained provide an identification of an animal as an output.

In block 504, the processor may perform a plurality of simulations of outcomes for the vehicle and other vehicles resulting from stimulating the identified animal using multiple different stimuli modes of the vehicle signal devices in which each different stimuli mode is predicted to elicit different animal behaviors. As described, such simulations may be configured to estimate the consequences to the vehicle as well as nearby vehicles of the course of events that could result from stimulating the detected animal to behave (i.e., freeze or move in a particular direction or manner) in a selected manner using particular stimulus generated by the vehicle (e.g., emitting a combination of lights and sound). In the simulations conducted in block 504, the processor may draw on information in a database or machine-learning model of animal behaviors in response to stimuli accessible to the processor, which may identify for each of a plurality of animals (including species, sex and size) a probability with which each of a plurality of behaviors may be elicited by each of a plurality of stimuli that the animals respond to and that the vehicle can produce. In embodiments employing a machine-learning model of animal behaviors, the processor may provide as input a selected stimuli pattern to the trained AI model that in response generates as an output of animal behavior(s). By simulating the outcomes for vehicles resulting from animal behaviors (e.g., move right, move left, move forward, move backward, or stay still) of each type of stimulus in the database, the processor may identify a range of possible outcomes that could result from producing the stimuli. As described, such simulations performed in block 504 may be based on or take into account the identified animal, the vehicle's distance to the animal, the vehicle's speed, locations and velocities of other nearby vehicles, road geometries, one or more road conditions, one or more traffic conditions, ambient lighting conditions, weather conditions, and the like.

In some embodiments, the simulations performed in block 504 may use Monte Carlo simulation techniques to model variability or probabilities of alternative animal behaviors in response to each stimuli mode, variability or probabilities of vehicle braking and steering performance, and variability or probabilities of different reactions of the driver of the vehicle and drivers of other vehicles.

In some embodiments, the number of simulations performed, and the number of different outcomes predicted may depend on the number of alternative behaviors associated with different modes of stimulation that are included in the database for the type (species, sex, size, etc.) of detected animal. Thus, the simulations conducted in block 504 may model likely outcomes for the vehicle and nearby vehicles resulting from using each of the different stimulations to trigger each of the corresponding behaviors. In this manner, the simulations may provide a basis on which to select one of the alternative stimulation modes.

As described above, in some embodiments, the plurality of simulations of outcomes for the vehicle and other vehicles resulting from stimulating the identified animal using multiple different stimuli modes of the vehicle signal devices may be performed offline to generate a training database of sensor, map, date/time, and traffic inputs and selected stimulations as a truth set. In such embodiments, the operations in block 504 may include running the plurality of simulations to generate the training database and applying the training database to a machine learning model to generate a trained AI model that can be implemented in a vehicle processor.

In block 506, the processor may use the outcomes predicted by the simulations to select one of the alternative stimulus modes to be performed by the vehicle signal devices. In some embodiments, the processor may select the stimulus mode that the simulations indicate will elicit a behavior of the identified animal that results in a best one (e.g., least damage, lowest probability of injury, least risky, etc.) of alternative outcomes for the vehicle and other vehicles predicted by the plurality of simulations. For example, the processor may use the simulation results to select the stimulus mode for vehicle signaling devices that the simulations show is most likely to elicit a specific identified behavior of the animal that will enable the vehicle and other nearby vehicles to either avoid colliding with the animal or resulting in the least damage if the animal cannot be avoided.

In some embodiments, the operations in block 506 may included applying at least vehicle sensor, map and traffic data into the trained AI model in the vehicle processor and receiving as an output one of the different stimuli modes to be performed by vehicle signal devices.

In block 508, the processor may control the vehicle signal devices to producing the selected stimulus. For example, the processor may control vehicle signal devices, including lights, and horns or another sound emitting devices, of the vehicle to perform or generate the selected stimulus. Vehicles may be equipped with a range of signal devices. In some embodiments, the vehicle may include illumination devices configured to emit light that is visible only by certain animals, such as infrared. In some embodiments, the vehicle may be equipped with sound generating devices (e.g., ultrasound emitters, speakers, etc.) configured to emit sounds to which some animals react, such as ultrasound, high pitch whistles, infrasound, etc.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

Implementation examples are described in the following paragraphs. While some of the following implementation examples are described in terms of example methods, further example implementations may include: the example methods discussed in the following paragraphs implemented by a computing device including a processor configured with processor-executable instructions to perform operations of the methods of the following implementation examples; the example methods discussed in the following paragraphs implemented by a computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method performed by a vehicle processing system for stimulating animal behavior, including performing a recognition process to identify an animal detected in proximity to the vehicle, performing a plurality of simulations of outcomes for the vehicle and other vehicles resulting from stimulating the identified animal using multiple different stimuli modes of the vehicle signal devices in which each different stimuli mode is predicted to elicit different animal behaviors, selecting one of the different stimuli modes to be performed by vehicle signal devices to elicit a behavior of the identified animal based on the plurality of simulated outcomes for the vehicle and other vehicles, and controlling the vehicle signal devices to perform the selected stimulus mode.

Example 2. The method of example 1, in which the plurality of simulations of outcomes for the vehicle and other vehicles resulting from stimulating the identified animal using multiple different stimuli modes of the vehicle signal devices use information regarding behaviors of the identified animal obtained from a database accessible by a processor of the vehicle.

Example 3. The method of either of examples 1 or 2, in which the plurality of simulations of outcomes for the vehicle and other vehicles resulting from stimulating the identified animal using multiple different stimuli modes of the vehicle signal devices use information regarding behaviors of the identified animal provided as an output by a trained AI model executed by a processor of the vehicle.

Example 4. The method of any of examples 1-3, further including identifying one or more road conditions, in which the plurality of simulations of outcomes for the vehicle and other vehicles resulting from stimulating the identified animal using multiple different stimuli modes of the vehicle signal devices take into account the identified one or more road conditions.

Example 5. The method of any of examples 1-4, further including identifying one or more traffic conditions, in which the plurality of simulations of outcomes for the vehicle and other vehicles resulting from stimulating the identified animal using multiple different stimuli modes of the vehicle signal devices take into account the identified one or more traffic conditions.

Example 6. The method of any of examples 1-5, further including identifying ambient lighting conditions, in which the plurality of simulations of outcomes for the vehicle and other vehicles resulting from stimulating the identified animal using multiple different stimuli modes of the vehicle signal devices take into account the identified ambient lighting conditions.

Example 7. The method of any of examples 16, further including identifying one or more weather conditions, in which the plurality of simulations of outcomes for the vehicle and other vehicles resulting from stimulating the identified animal using multiple different stimuli modes of the vehicle signal devices take into account the identified one or more one or more weather conditions.

Example 8. The method of any of examples 1-7, in which the plurality of simulations of outcomes for the vehicle and other vehicles resulting from stimulating the identified animal using multiple different stimuli modes of the vehicle signal devices take into account probabilities of each of a plurality of behaviors that the identified animal may perform in response to each stimulus mode.

Example 9. The method of any of examples 1-8, in which performing the plurality of simulations of outcomes for the vehicle and other vehicles resulting from stimulating the identified animal using multiple different stimuli modes of the vehicle signal devices includes performing Monte Carlo simulations of outcomes for the vehicle and other vehicles that take into account probabilities of animal behaviors, vehicle behaviors, and driver reactions.

Example 10. The method of any of examples 1-9, in which: performing a plurality of simulations of outcomes for the vehicle and other vehicles resulting from stimulating the identified animal using multiple different stimuli modes of the vehicle signal devices in which each different stimuli mode is predicted to elicit different animal behaviors includes performing the plurality of simulations of outcomes for the vehicle and other vehicles in offline simulations to generate a training database, and applying the training database to a machine learning model to generate a trained artificial intelligence (AI) model that can be implemented in a vehicle processor; and selecting one of the different stimuli modes to be performed by vehicle signal devices to elicit a behavior of the identified animal based on the plurality of simulated outcomes for the vehicle and other vehicles includes applying at least vehicle sensor, map and traffic data into the trained AI model in the vehicle processor and receiving as an output one of the different stimuli modes to be performed by vehicle signal devices.

The foregoing method descriptions and the process flow diagrams are provided merely as illustrative examples and are not intended to require or imply that the operations of various embodiments must be performed in the order presented. As will be appreciated by one of skill in the art the operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processing system of a vehicle for stimulating animal behavior, comprising:
performing a recognition process to identify an animal detected in proximity to the vehicle;
performing a plurality of simulations of outcomes for the vehicle and other vehicles resulting from stimulating the identified animal using multiple different stimuli modes of the vehicle signal devices in which each different stimuli mode is predicted to elicit different animal behaviors;
selecting one of the different stimuli modes to be performed by vehicle signal devices to elicit a behavior of the identified animal based on the plurality of simulated outcomes for the vehicle and other vehicles; and
controlling the vehicle signal devices to perform the selected stimulus mode.

2. The method of claim 1, wherein the plurality of simulations of outcomes for the vehicle and other vehicles resulting from stimulating the identified animal using multiple different stimuli modes of the vehicle signal devices use information regarding behaviors of the identified animal obtained from a database accessible by a processor of the vehicle.

3. The method of claim 1, wherein the plurality of simulations of outcomes for the vehicle and other vehicles resulting from stimulating the identified animal using multiple different stimuli modes of the vehicle signal devices use information regarding behaviors of the identified animal provided as an output by a trained artificial intelligence (AI) model executed by a processor of the vehicle.

4. The method of claim 1, further comprising identifying one or more road conditions, wherein the plurality of simulations of outcomes for the vehicle and other vehicles resulting from stimulating the identified animal using multiple different stimuli modes of the vehicle signal devices take into account the identified one or more road conditions.

5. The method of claim 1, further comprising identifying one or more traffic conditions, wherein the plurality of simulations of outcomes for the vehicle and other vehicles resulting from stimulating the identified animal using multiple different stimuli modes of the vehicle signal devices take into account the identified one or more traffic conditions.

6. The method of claim 1, further comprising identifying ambient lighting conditions, wherein the plurality of simulations of outcomes for the vehicle and other vehicles resulting from stimulating the identified animal using multiple different stimuli modes of the vehicle signal devices take into account the identified ambient lighting conditions.

7. The method of claim 1, further comprising identifying one or more weather conditions, wherein the plurality of simulations of outcomes for the vehicle and other vehicles resulting from stimulating the identified animal using multiple different stimuli modes of the vehicle signal devices take into account the identified one or more one or more weather conditions.

8. The method of claim 1, wherein the plurality of simulations of outcomes for the vehicle and other vehicles resulting from stimulating the identified animal using multiple different stimuli modes of the vehicle signal devices take into account probabilities of each of a plurality of behaviors that the identified animal may perform in response to each stimulus mode.

9. The method of claim 1, wherein performing the plurality of simulations of outcomes for the vehicle and other vehicles resulting from stimulating the identified animal using multiple different stimuli modes of the vehicle signal devices comprises performing Monte Carlo simulations of outcomes for the vehicle and other vehicles that take into account probabilities of animal behaviors, vehicle behaviors, and driver reactions.

10. The method of claim 1, wherein:
performing a plurality of simulations of outcomes for the vehicle and other vehicles resulting from stimulating the identified animal using multiple different stimuli modes of the vehicle signal devices in which each different stimuli mode is predicted to elicit different animal behaviors comprises performing the plurality of simulations of outcomes for the vehicle and other vehicles in offline simulations to generate a training database, and applying the training database to a machine learning model to generate a trained artificial intelligence (AI) model that can be implemented in a vehicle processor; and
selecting one of the different stimuli modes to be performed by vehicle signal devices to elicit a behavior of the identified animal based on the plurality of simulated outcomes for the vehicle and other vehicles comprises applying at least vehicle sensor, map and traffic data into the trained AI model in the vehicle processor and receiving as an output one of the different stimuli modes to be performed by vehicle signal devices.

11. A vehicle processing system, comprising:
a processor configured with processor-executable instructions to:
perform a recognition process to identify an animal detected in proximity to a vehicle including the vehicle processing system;
perform a plurality of simulations of outcomes for the vehicle and other vehicles resulting from stimulating the identified animal using multiple different stimuli modes of the vehicle signal devices in which each different stimuli mode is predicted to elicit different animal behaviors;
select one of the different stimuli modes to be performed by vehicle signal devices to elicit a behavior of the identified animal based on the plurality of simulated outcomes for the vehicle and other vehicles; and
control the vehicle signal devices to perform the selected stimulus mode.

12. The vehicle processing system of claim 11, wherein the processor is further configured with processor-executable instructions such that the plurality of simulations of outcomes for the vehicle and other vehicles resulting from stimulating the identified animal using multiple different stimuli modes of the vehicle signal devices use information regarding behaviors of the identified animal obtained from a database accessible by the processor of the vehicle.

13. The vehicle processing system of claim 11, wherein the processor is further configured with processor-executable instructions such that the plurality of simulations of outcomes for the vehicle and other vehicles resulting from stimulating the identified animal using multiple different stimuli modes of the vehicle signal devices use information regarding behaviors of the identified animal provided as an output by a trained artificial intelligence (AI) model executed by the processor of the vehicle.

14. The vehicle processing system of claim 11, wherein:
the processor is further configured with processor-executable instructions to identify one or more road conditions; and
the plurality of simulations of outcomes for the vehicle and other vehicles resulting from stimulating the identified animal using multiple different stimuli modes of the vehicle signal devices take into account the identified one or more road conditions.

15. The vehicle processing system of claim 11, wherein:
the processor is further configured with processor-executable instructions to identify one or more traffic conditions; and
the plurality of simulations of outcomes for the vehicle and other vehicles resulting from stimulating the identified animal using multiple different stimuli modes of the vehicle signal devices take into account the identified one or more traffic conditions.

16. The vehicle processing system of claim 11, wherein:
the processor is further configured with processor-executable instructions to identify ambient lighting conditions; and
the plurality of simulations of outcomes for the vehicle and other vehicles resulting from stimulating the identified animal using multiple different stimuli modes of the vehicle signal devices take into account the identified ambient lighting conditions.

17. The vehicle processing system of claim 11, wherein:
the processor is further configured with processor-executable instructions to identify one or more weather conditions; and
the plurality of simulations of outcomes for the vehicle and other vehicles resulting from stimulating the identified animal using multiple different stimuli modes of the vehicle signal devices take into account the identified one or more one or more weather conditions.

18. The vehicle processing system of claim 11, wherein the processor is further configured with processor-executable instructions such that the plurality of simulations of outcomes for the vehicle and other vehicles resulting from stimulating the identified animal using multiple different stimuli modes of the vehicle signal devices take into account probabilities of each of a plurality of behaviors that the identified animal may perform in response to each stimulus mode.

19. The vehicle processing system of claim 11, wherein the processor is further configured with processor-executable instructions to perform Monte Carlo simulations of outcomes for the vehicle and other vehicles that take into account probabilities of animal behaviors, vehicle behaviors, and driver reactions.

20. A vehicle processing system, comprising:
means for performing a recognition process to identify an animal detected in proximity to a vehicle including the vehicle processing system;
means for performing a plurality of simulations of outcomes for the vehicle and other vehicles resulting from stimulating the identified animal using multiple different stimuli modes of the vehicle signal devices in which each different stimuli mode is predicted to elicit different animal behaviors;
means for selecting one of the different stimuli modes to be performed by vehicle signal devices to elicit a behavior of the identified animal based on the plurality of simulated outcomes for the vehicle and other vehicles; and
means for controlling the vehicle signal devices to perform the selected stimulus mode.

21. The vehicle processing system of claim 20, wherein the plurality of simulations of outcomes for the vehicle and other vehicles resulting from stimulating the identified animal using multiple different stimuli modes of the vehicle signal devices use information regarding behaviors of the identified animal obtained from a database accessible by a processor of the vehicle.

22. The vehicle processing system of claim 20, wherein the plurality of simulations of outcomes for the vehicle and other vehicles resulting from stimulating the identified animal using multiple different stimuli modes of the vehicle signal devices use information regarding behaviors of the identified animal provided as an output by a trained artificial intelligence (AI) model executed by a processor of the vehicle.

23. The vehicle processing system of claim 20, further comprising means for identifying one or more road conditions, wherein the plurality of simulations of outcomes for the vehicle and other vehicles resulting from stimulating the identified animal using multiple different stimuli modes of the vehicle signal devices take into account the identified one or more road conditions.

24. The vehicle processing system of claim 20, further comprising means for identifying one or more traffic conditions, wherein the plurality of simulations of outcomes for the vehicle and other vehicles resulting from stimulating the identified animal using multiple different stimuli modes of the vehicle signal devices take into account the identified one or more traffic conditions.

25. The vehicle processing system of claim 20, further comprising means for identifying ambient lighting conditions, wherein the plurality of simulations of outcomes for the vehicle and other vehicles resulting from stimulating the identified animal using multiple different stimuli modes of the vehicle signal devices take into account the identified ambient lighting conditions.

26. The vehicle processing system of claim 20, further comprising means for identifying one or more weather conditions, wherein the plurality of simulations of outcomes for the vehicle and other vehicles resulting from stimulating the identified animal using multiple different stimuli modes of the vehicle signal devices take into account the identified one or more one or more weather conditions.

27. The vehicle processing system of claim 20, wherein the plurality of simulations of outcomes for the vehicle and other vehicles resulting from stimulating the identified animal using multiple different stimuli modes of the vehicle signal devices take into account probabilities of each of a plurality of behaviors that the identified animal may perform in response to each stimulus mode.

28. The vehicle processing system of claim 20, wherein performing the plurality of simulations of outcomes for the vehicle and other vehicles resulting from stimulating the identified animal using multiple different stimuli modes of the vehicle signal devices comprises performing Monte Carlo simulations of outcomes for the vehicle and other vehicles that take into account probabilities of animal behaviors, vehicle behaviors, and driver reactions.

29. A non-transitory processor-readable medium having stored thereon processor-executable instructions configured to cause a processor in a vehicle processing system within a vehicle to perform operations comprising:
performing a recognition process to identify an animal detected in proximity to the vehicle;
performing a plurality of simulations of outcomes for the vehicle and other vehicles resulting from stimulating the identified animal using multiple different stimuli modes of the vehicle signal devices in which each different stimuli mode is predicted to elicit different animal behaviors;
selecting one of the different stimuli modes to be performed by vehicle signal devices to elicit a behavior of the identified animal based on the plurality of simulated outcomes for the vehicle and other vehicles; and
controlling the vehicle signal devices to perform the selected stimulus mode.

30. The non-transitory processor-readable medium of claim 29, wherein the stored processor-executable instructions are further configured to cause the processor in the vehicle processing system to perform operations such that the plurality of simulations of outcomes for the vehicle and other vehicles resulting from stimulating the identified animal using multiple different stimuli modes of the vehicle signal devices use information regarding behaviors of the identified animal obtained from one or both of a database accessible by the processor or a trained artificial intelligence (AI) model executed by the processor.
